(19) United States
(12) Patent Application Publication
(10) Pub. No.: US 2018/0115330 A1
(43) Pub. Date: Apr. 26, 2018

(54) REMOTE CONTROL

(71) Applicant: Yuneec International (China) Co., Ltd., Kunshan City, Jiangsu Province (CN)

(72) Inventors: Yu TIAN, Kunshan, Jiangsu (CN); Wenyan JIANG, Kunshan, Jiangsu (CN)

(21) Appl. No.: 15/536,627

(22) PCT Filed: Dec. 15, 2015
(86) PCT No.: PCT/CN2015/097352

§ 371 Date: Jun. 15, 2017

(30) Foreign Application Priority Data
Dec. 15, 2014 (CN) 201420795980.4

(51) Int. Cl. H04B 1/00; H04B 1/3827; H04B 1/401; H04N 7/20; H04N 5/232; H04N 7/18; G05D 1/00

(52) U.S. Cl. CPC H04B 1/0064; H04B 1/3833; H04B 1/401; H04N 7/20; H04N 5/23203; G05D 1/0016; H04N 7/185; H04N 5/23293; H04N 5/23296; G05D 1/0038; G05D 1/0022; H04N 5/23245

(57) ABSTRACT

The invention provides a remote control, comprising two control rods for sending a direction signal, a speed adjusting knob for sending a speed signal, a first antenna for transmitting a control signal, a second antenna for transmitting an image signal, an interface for displaying images and a mode selection switch for switching mode signal.

This application claims the priority of the Chinese patent application CN201420795980.4 filed on Dec. 15, 2014, which is incorporated herein by reference.

### TECHNICAL FIELD

The invention relates to the UAV (unmanned aerial vehicle) aerial photograph field, especially a kind of remote control.

### BACKGROUND ART

As an important way to acquire spatial data, UAV aerial photograph features the advantages of available at any time, real-time transmission, low cost and no need to report to the air control authority etc. It is widely used in film and television shooting, news framing, aerial monitoring and ecological maintenance etc. Remote control is an indispensable equipment for UAV aerial photograph, and the existing remote control design are quite different. The same antenna is used both for the transmission of control signal and image signal, while the two signals would affect each other, resulting in inaccurate controlling of the remote control and inaccurate receiving of image signal. Additionally, the UAV photograph angle is not controlled by the remote control, making it inconvenient for users to use.

### CONTENTS OF THE INVENTION

The technical problem to be solved by the invention is to overcome the drawbacks existing in the current remote controls, such as unprecise controlling and inaccurate receiving of image signal etc., and to provide a convenient, practical and precise controlling remote control.

The invention uses the following technical schemes to solve the above-mentioned technical problems:

A remote control comprises two control rods for sending a direction signal, a speed adjusting knob for sending a speed signal, a first antenna for transmitting a control signal, a second antenna for transmitting an image signal, an interface for displaying images and a mode selection switch for switching mode signals.

The side of the remote control is provided with an annular shell, inside which the first antenna is located. The speed adjusting knob is located on the side adjacent to the side of the remote control where the annular shell is installed; the second antenna is located on the upper surface of the remote control, and at the side close to the annular shell; the mode selection switch is located on the upper part of the remote control and at the side close to the second antenna; the display interface is located on the upper surface and the side far away from the annular shell; the control rods are located between the mode selection switch and the display interface. The control rods, the speed adjusting knob, the first antenna, the second antenna, the display interface and the mode selection switch are all connected with the control panel of the remote control electrically.

In this invention, the remote control controls the unmanned aerial camera through the first antenna and receives the image signal transmitted from the unmanned aerial camera through the second antenna. The control signal and the image signal are transmitted through different antennas so that the control signal and the image signal would not affect each other. The side of the remote control is covered with a shell, and there is an empty annular hole between the shell and the remote control, forming the annular shell mentioned in this scheme. Wherein the first antenna is located inside the annular shell at the side of the remote control, which is of the portable type. Users could see the images photographed by the real-time unmanned aerial camera through the display interface, and switch the mode with mode selection switch, which is convenient to operate.

Preferably, the remote control further comprises an angle adjusting knob for sending an angle signal, which is connected with the control panel electrically, the angle adjusting knob is located on the opposite side where there is an speed adjusting knob. The shooting angle of the unmanned aerial camera can be adjusted so as to change the shooting angle by adjusting the angle adjusting knob.

Preferably, the first antenna is a 2.4 GHz antenna and the second antenna is a 5.8 GHz antenna. The antennas of different frequency bands are used to transmit control signal and image signal separately.

Preferably, in the upper surface of the remote control, there is a shooting button on the left side of the second antenna and a video button on the right side of the second antenna; the shooting button and video button are electrically connected to the control panel. The shooting button is used to output the shooting signal to the first antenna, and the video button is used to output the video signal to the second antenna. When pressing the shooting button, the first antenna will transmit the shooting signal to the unmanned aerial camera, and the unmanned aerial camera will start to shoot; when pressing the video button, the first antenna will transmit the video signal to the unmanned aerial camera; and the unmanned aerial camera will start to record. The second antenna can also be used to transmit a command signal for controlling the lens zoom and other signals. In addition, the movement of the pan-tilt can be controlled by the second antenna or the first antenna.

Preferably, the remote control is further provided with a USB port which is electrically connected to the control panel; the USB port is located on the side of the remote control where the speed adjustment knob is provided. The remote control is charged through the USB port.

Preferably, the upper surface of the remote control is further provided with an LED indicator, which is electrically connected to the control panel. The LED indicator is located between the two control rods, and the LED indicator comprises a charging indicator, a WIFI indicator and a GPS indicator.

Preferably, the remote control is further provided with an earphone port, which is electrically connected to the control panel; the earphone port is located on the side of the remote control, where the speed adjusting knob is provided.

Preferably, the remote control is further provided with a card slot for storing a memory card, which is located on the side e of the remote control where the speed adjusting knob is provided. The card slot is used to place a memory card for storing the image signal received by the remote control.

Preferably, there is also a power switch electrically connected to the control panel, which is located between the two mode selection switches, and a start/stop button is provided on the left side of the mode selection button. The start/stop button is used to control the starting and stopping of the motor of the unmanned aerial camera.

Preferably, the display interface is a touchable display screen.

The positive progress effect of the invention lies in that: compared with the existing remote control, this invention designs the separate antennas for the control signal transmission and the image signal transmission, realizing the effects including no interaction between the control signal and the image signal of the remote control, precise signal control and accurate receiving of image signal, meanwhile, the structure of this invention is simple and it is easy to use.

### DESCRIPTION OF FIGURES

FIG. 1 is the front view of the remote control in the embodiment of the invention.

FIG. 2 is the left view of the remote control in the embodiment of the invention.

FIG. 3 is the right view of the remote control in the embodiment of the invention.

### DESCRIPTION OF SIGNS IN THE FIGURES

| | | | |
|---|---|---|---|
| 2.4 GHz Antenna | 1 | 5.8 GHz Antenna | 2 |
| Control rods | 3 | Touchable display screen | 4 |
| Speed adjusting knob | 5 | Angle adjusting knob | 6 |
| Shooting button | 7 | Video button | 8 |
| Start/stop bottom | 9 | Mode selection switch | 10 |
| Power switch | 11 | LED indicator | 12 |
| USB port | 13 | Earphone port | 14 |
| Card slot | 15 | | |
| Right side of remote control | A | Left side of remote control | B |
| Upper side of remote control | C | Upper side of remote control | D |

### SPECIFIC EMBODIMENTS

Now, a much clear and complete instruction will be given below to this invention with a preferred embodiment of this invention combining the attached drawings.

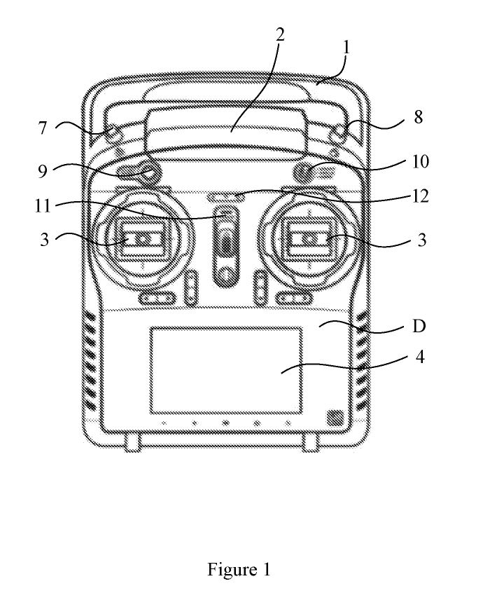

As shown in FIGS. 1 to 3, a remote control includes a 2.4 GHz antenna 1 for transmitting the control signal, a 5.8 GHz antenna 2 for transmitting an image signal, two control rods 3 for transmitting a direction signal, a touchable display screen 4 for displaying an image, a speed adjusting knob 5 for transmitting the speed signal, an angle adjusting knob 6 for sending an angle signal, a shooting button 7, a video button 8, a start/stop button 9, a mode selection switch 10 for switching the mode signal, a power switch 11, an LED indicator 12, a USB port 13, an earphone port 14, and a card slot 15 inside which a memory card is placed.

In the preferred embodiment of this invention, side A, B, C, D represent the right side, the left side, the upper side and the upper surface respectively; the speed adjusting knob 5, the USB port 13 and the earphone port 14 of the remote control in FIG. 1, all are located on side A of the remote control; the angle adjusting knob 6 is located on side B of the remote control, 5.8 GHz antenna 2 is located on side C of the remote control; while the touchable display screen 4, shooting button 7, video button 8, start/stop button 9, mode selection bottom 10, the power switch 11 and the LED indicator 12 all are located on D side of the remote control, and the card slot 15 is located on the back of the remote control.

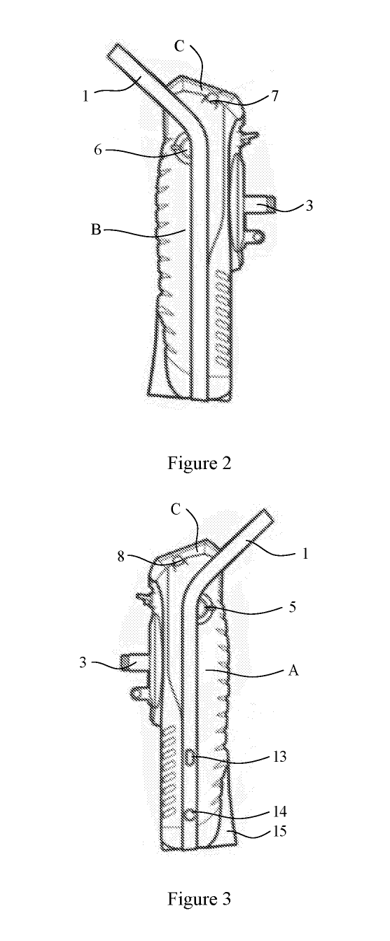

The side of the remote control is provided with an annular shell inside which the 2.4 GHz antenna is provided. As shown in FIG. 1, the 5.8 GHz antenna 2 is located on the upper part of side D of the remote control, the shooting button 7 is located on the left side of the 5.8 GHz antenna 2, the video button 8 is located on the right side of the 5.8 GHz antenna 2, the start/stop button 9 is located below the shooting button 7, the mode selection switch 10 is located below the video button 8, the touchable display screen 4 is located on the lower part of side D of the remote control, and the control rods 3 are located between the mode selection switch 10 and the touchable display screen 4. As shown in FIG. 2, the angle adjusting knob 6 is located on the upper part of side B of the remote control. As shown in FIG. 3, the speed adjusting knob 5 is located on the upper part of side A of the remote control, the USB port 13 is located on the lower part of side A of the remote control, and the earphone port 14 is located on lower part of the USB port 13.

The 2.4 GHz antenna 1, the 5.8 GHz antenna 2, the control rod 3, the touchable display screen 4, the speed adjusting button 5, the angle adjusting knob 6, the shooting button 7, the video button 8, the start/stop button 9, the mode selection switch 10, the power switch 11, the LED indicator 12, the USB port 13, the earphone port 14, and the card slot 15 are electrically connected to the control panel of the remote control.

While the specific embodiments of the invention have been described above, it shall be understood by those technicians skilled in this field that these are merely illustrative instruction, and that various changes or modifications may be made to these embodiments under the premise of not departing from the principle and spirit of the invention. Therefore, the scope of the invention is defined by the appended claims.

1. A remote control, comprising: two control rods for sending a direction signal, a speed adjusting knob for sending a speed signal, a first antenna for transmitting a control signal, a second antenna for transmitting an image signal, an interface for displaying images and a mode selection switch for switching mode signals;
the side of the remote control is provided with an annular shell, inside which the first antenna is located; the speed adjusting knob is located on the side adjacent to the side of the remote control where the annular shell is installed; the second antenna is located on the upper surface of the remote control, and at the side close to the annular shell; the mode selection switch is located on the upper part of the remote control and at the side close to the second antenna; the display interface is located on the upper surface and the side far away from the annular shell; the control rods are located between the mode selection switch and the display interface; the control rods, the speed adjusting knob, the first antenna, the second antenna, the display interface and the mode selection switch are all connected with the control panel of the remote control electrically.

2. The remote control of claim 1, wherein the remote control further comprises an angle adjusting knob for sending an angle signal, which is connected with the control panel electrically, the angle adjusting knob is located on the side opposite to the side where the speed adjusting knob is provided.

3. The remote control of claim 1, wherein the first antenna is a 2.4 GHz antenna and the second antenna is a 5.8 GHz antenna.

4. The remote control of the claim 1, wherein a shooting button on the left side of the second antenna and a video button on the right side of the second antenna is provided in the upper surface of the remote control; the shooting button and video button are electrically connected to the control panel; the shooting button is used to output the shooting signal to the first antenna, and the video button is used to output the video signal to the second antenna.

5. The remote control of the claim 1, wherein the remote control is further provided with a USB port which is electrically connected to the control panel; the USB port is located on the side of the remote control where the speed adjustment knob is provided.

6. The remote control of claim 5, wherein the upper surface of the remote control is further provided with an LED indicator, which is electrically connected to the control panel; the LED indicator is located between the two control rods and the LED indicator comprises a charging indicator, a WIFI indicator and a GPS indicator.

7. The remote control of claim 1, wherein the remote control is further provided with a earphone port, which is electrically connected to the control panel; the earphone port is located on the side of the remote control where the speed adjusting knob is provided.

8. The remote control of claim 1, wherein the remote control is further provided with a card slot for storing a memory card; the card slot 15 is located on the back of the remote control.

9. The remote control of the claim 1, wherein there is also provided with a power switch electrically connected to the control panel, which is located between the two mode selection switches, and a start/stop button is provided on the left side of the mode selection buttons.

10. The remote control of claim 1, wherein the display interface is a touchable display screen.
